(19) United States
(12) Patent Application Publication
(10) Pub. No.: US 2025/0080670 A1
(43) Pub. Date: Mar. 6, 2025

(54) IMAGE FORMING APPARATUS AND OPERATION METHOD OF IMAGE FORMING APPARATUS

(71) Applicant: SHARP KABUSHIKI KAISHA, Sakai City (JP)

(72) Inventor: TSUTOMU ITAI, Sakai City (JP)

(21) Appl. No.: 18/821,864

(22) Filed: Aug. 30, 2024

(30) Foreign Application Priority Data
Sep. 6, 2023 (JP) 2023-144626

(51) Int. Cl. H04N 1/00

(52) U.S. Cl. CPC H04N 1/00503; H04N 1/00506; H04N 2201/0094

(57) ABSTRACT

An image forming apparatus including one or more controllers and a display displays, when a screen corresponding to a first operation mode is displayed on the display, a logout related display on the screen corresponding to the first operation mode in a first display form, and displays, when a screen corresponding to a second operation mode is displayed on the display, the logout related display on the screen corresponding to the second operation mode in a second display form different from the first display form.

### TECHNICAL FIELD

The disclosure relates to an image forming apparatus and the like.

### BACKGROUND ART

Certain multi-function peripherals/printers (MFPs) and other image forming apparatuses allow configuration of whether to display a login screen. Typically, the login screen includes input fields for inputting a user name and a password, and a user who wants to log in enters his/her user name and password on the login screen.

In this regard, it is known as the prior art that, when login is successful, a logout button containing the user name is displayed on the screen of the display.

### SUMMARY

### Technical Problem

A problem to be solved by the disclosure is to provide an image forming apparatus capable of executing a logout related display in a display form corresponding to an operation mode.

### Solution to Problem

To solve the problem described above, the disclosure provides an image forming apparatus including one or more controllers and a display. The one or more controllers display, when a screen corresponding to a first operation mode is displayed on the display, a logout related display on the screen corresponding to the first operation mode in a first display form, and displays, when a screen corresponding to a second operation mode is displayed on the display, the logout related display on the screen corresponding to the second operation mode in a second display form different from the first display form.

Further, the disclosure provides an operation method of an image forming apparatus including one or more controllers and a display, the operation method including causing one or more controllers to display, when a screen corresponding to a first operation mode is displayed on the display, a logout related display on the screen corresponding to the first operation mode in a first display form, and display, when a screen corresponding to a second operation mode is displayed on the display, the logout related display on the screen corresponding to the second operation mode in a second display form different from the first display form.

### Advantageous Effects of Invention

According to the disclosure, it is possible to provide an image forming apparatus capable of executing a logout related display in a display form corresponding to an operation mode.

### BRIEF DESCRIPTION OF DRAWINGS

FIG. 1A and FIG. 1B illustrate views for explaining a logout button displayed in a system region of a typical image forming apparatus, FIG. 1A being an example of a system region of a home screen before login, and FIG. 1B being an example of the system region of the home screen after login.

FIG. 2 is a functional block diagram of an image forming system according to an embodiment of the disclosure.

FIG. 3 is a functional block diagram of an image forming apparatus according to the embodiment of the disclosure.

FIG. 4 is a flowchart for explaining operation of the image forming apparatus according to the embodiment of the disclosure.

FIG. 5 is an example of a login screen displayed on a display of the image forming apparatus according to the embodiment of the disclosure.

FIG. 6 is an example of a home screen displayed on the display of the image forming apparatus according to the embodiment of the disclosure.

FIG. 7 is an example of a copy screen displayed on the display of the image forming apparatus according to the embodiment of the disclosure.

FIG. 8 is another example of a copy screen displayed on the display of the image forming apparatus according to the embodiment of the disclosure.

FIG. 9A to FIG. 9H illustrate examples of the system region displayed on the display of the image forming apparatus according to the embodiment of the disclosure. FIGS. 9A, 9B, and 9C are examples of system regions of the home screen. FIG. 9D is an example of a system region of the copy screen. FIG. 9E is an example of a system region of a scan screen. FIG. 9F is an example of a system region of a fax screen. FIG. 9G is an example of a system region of a hold print screen. FIG. 9H is an example of a system region of a direct print screen.

FIG. 10 is an example of the copy screen displayed on the display of the image forming apparatus according to a second embodiment of the disclosure.

FIG. 11 is a flowchart for explaining operation of the image forming apparatus according to a third embodiment of the disclosure.

FIG. 12 is a flowchart for explaining operation of the image forming apparatus according to a fourth embodiment of the disclosure.

FIG. 13 is a flowchart for explaining operation of the image forming apparatus according to a fifth embodiment of the disclosure.

### DESCRIPTION OF EMBODIMENTS

Typically, in an image forming apparatus, after user authentication is completed and login is performed, logout is possible at any desired timing.

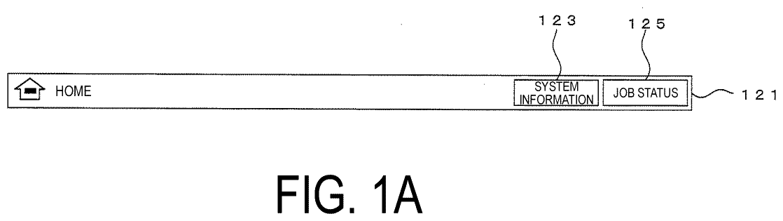

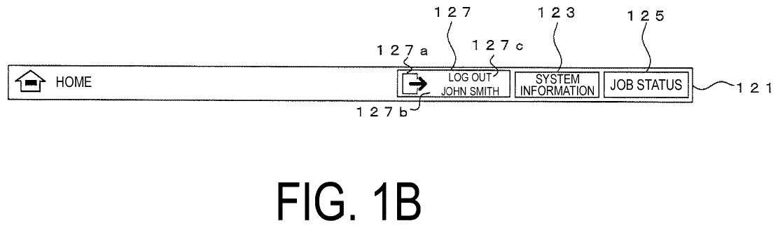

For example, FIGS. 1A and 1B are examples of screens displayed on a touch display of a typical image forming apparatus as compared with an image forming apparatus of the disclosure. FIG. 1A illustrates an example of a system region of a home screen before login.

FIG. 1B illustrates an example of the system region of the home screen after login. As illustrated in FIG. 1A, a system information button 123 and a job status button 125 are displayed at a right end of a system region 121 before login. When a user logs in, as illustrated in FIG. 1B, a logout button 127 is displayed on a left side of the system information button 123.

The logout button 127 is a button that, in response to touch, logs out the logged-in user. The logout button 127 includes an icon 127a, a user name display 127b, and a button name display 127c. In the user name display 127b, “John Smith” is displayed as the user name of the user currently logged in. With the logout button 127 displayed, there is an effect that the logged-in user can quickly log out simply by touching the logout button 127. Further, the user name display 127b allows a person other than the logged-in user to identify the logged-in user.

However, according to such an image forming apparatus, the logout button including the user name is displayed after login until logout. The display of the logout button is unproblematic when a screen size of the display of the image forming apparatus is sufficiently large. However, the screen size of the display of the image forming apparatus is typically limited. Therefore, when continuously displayed in a large size, the logout button occupies that much of the display region available on the screen of the display, making it problematically difficult to display other information on the screen of the display.

In view of such a problem, in the following embodiments, an image forming apparatus and the like capable of providing a suitable display mode to a user will be described.

### 1. First Embodiment

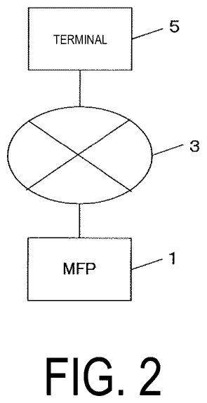

FIG. 2 is a functional block diagram of an image forming system 100 according to an embodiment of the disclosure. The image forming system 100 includes a multi-function peripheral/printer (MFP) 1, a network 3, and a terminal 5. The multi-function peripheral/printer 1 and the terminal 5 are connected to each other via the network 3, enabling data communication between the two.

The multi-function peripheral/printer 1 is one type of image forming apparatus. The multi-function peripheral/printer 1 has a copy function, a scan function, and a fax function, and further has a hold print function and a direct print function.

The network 3 is a data communication network. A configuration and a type of the data communication network constituting the network 3 are not particularly limited. The network 3 may be a wired network or a wireless network, or may be a mixture of both. For example, the network 3 may be configured by part or all of a local area network (LAN), a wide area network (WAN), the Internet, a mobile communication network, a fixed telephone network, and the like.

The terminal 5 is a terminal device capable of data communication, and may be, for example, a personal computer, a workstation, a tablet, or a smartphone.

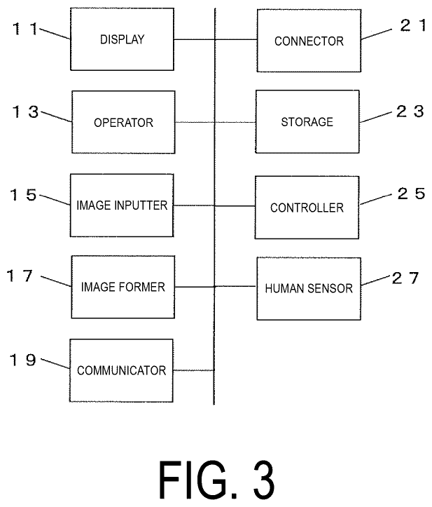

FIG. 3 is a functional block diagram of the multi-function peripheral/printer 1. The multi-function peripheral/printer 1 includes a display 11, an operation inputter 13, an image inputter 15, an image former 17, a communicator 19, a connector 21, a storage 23, a controller 25, and a human sensor 27.

The display 11 displays images and characters. The display 11 is constituted by, for example, a liquid crystal display (LCD) or an organic electro-luminescence (EL) panel. The display 11 may be a single display device, or may further include a display device connected to the outside.

The operation inputter 13 receives an operation input from the user. For example, the operation inputter 13 is constituted by hardware keys or software keys. Further, the operation inputter 13 includes task keys for executing tasks such as fax transmission and image reading, and a cancel key for canceling an operation, for example. Further, the operation inputter may include physical operation keys such as task keys, a cancel key, a power key, and a power-saving key. Note that, in the present embodiment, the display 11 and the operation inputter 13 are integrally configured as a touch display.

The image inputter 15 reads an image (document) and outputs the image as image data. The image inputter 15 is configured by a typical scanner (image input device). Further, the image inputter 15 may input image data from an external storage medium such as a universal serial bus (USB) memory via the connector 23, or may receive an image through a network via the communicator 19, for example.

The image former 17 forms (prints) an image on a medium such as a copy sheet on the basis of the image data. A printing method of the image former 17 is as desired, and may be, for example, any one of an inkjet printer, a laser printer, and a thermal transfer printer. The image former 17 may be a monochrome printer or a color printer. The image former 17 may include a paper feeding mechanism that feeds a medium, a conveyance mechanism that conveys a medium, a sorter mechanism that sorts media on which images have been formed, or the like.

The communicator 19 connects the multi-function peripheral/printer 1 to the network 3. For example, the communicator 19 is constituted by an interface connectible to a wired local area network (LAN), a wireless LAN, or a long term evolution (LTE) network. Connected to a network, the communicator 19 is connected to other devices or an external network. Further, the communicator 19 may otherwise be an interface that performs short-range wireless communication such as near field communication (NFC) or Bluetooth (trade name), for example.

The connector 21 connects the multi-function peripheral/printer 1 to another device. For example, the connector 21 is a USB interface, and a USB memory is connected thereto. Other than a USB interface, the connector 21 may be a High Definition Multimedia Interface (HDMI; trade name) interface or the like.

The storage 23 stores various programs and various data necessary for operation of the multi-function peripheral/printer 1. The storage 23 includes a recording device capable of temporary storage, such as a dynamic random access memory (DRAM), or a non-temporary recording device such as a solid state drive (SSD) constituted by a semiconductor memory or a hard disk drive (HDD) constituted by a magnetic disk. Further, although illustrated as a single component for convenience of description, the storage 23 may be configured as separate devices for each application, such as a region (main storage region) utilized for execution of a program, a region (auxiliary storage region) for storing programs or data, and a region utilized for a cache.

The controller 25 controls the entire multi-function peripheral/printer 1. The controller 25 is composed of, for example, one or more control devices or a control circuit, and is constituted by, for example, a central processing unit (CPU) or a system-on-chip (SoC).

Further, the controller 25 realizes each function by reading programs stored in the storage 23 and executing processes.

The human sensor 27 is a sensor that detects a person around the multi-function peripheral/printer 1, in particular, a person at a position facing the display 11 and the operation inputter 13. The type of the human sensor 27 is not particularly limited. The human sensor 27 may be, for example, an infrared sensor that detects a temperature change utilizing infrared rays, a sound sensor that detects sound, or an ultrasonic sensor that emits ultrasonic waves and detects reflection thereof.

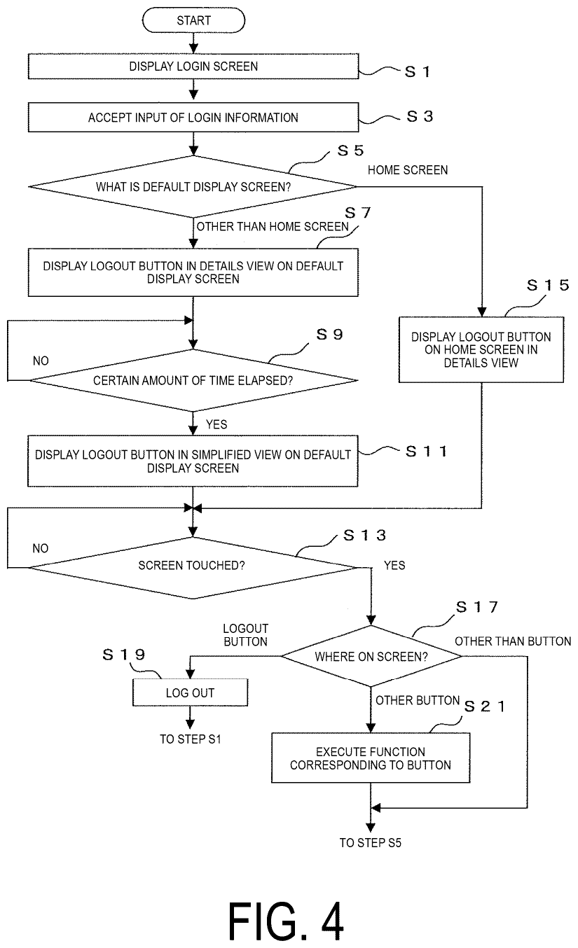

FIG. 4 is a flowchart for explaining the operation of the multi-function peripheral/printer 1. A screen to be displayed after login is preset as a default display screen in the multi-function peripheral/printer 1, and setting information thereof is stored in the storage 23. Screens that can be set as the default display screen are a home screen, a copy screen, a scan screen, a fax screen, a hold print screen, and a direct print screen. Each of these screens corresponds to one operation mode. An operation mode is a group of operations of the multi-function peripheral/printer 1 for a specific application, and corresponds to, for example, a subroutine of a control program that causes the CPU to operate as the controller 25. The multi-function peripheral/printer 1 has a plurality of operation modes and provides the user with different functions depending on the operation mode. Hereinafter, the operation modes corresponding to these screens are referred to as a home operation mode, a copy operation mode, a scan operation mode, a fax operation mode, a hold print operation mode, and a direct print operation mode. In particular, the home operation mode corresponds to a first operation mode and the operation modes other than the home operation mode correspond to a second operation mode.

The controller 25 displays a login screen on the display 11 (step S1). Next, the controller 25 receives input of login information via the operation inputter 13 (step S3).

In steps S1 and S3, the user who logs in may input login information via the operation inputter 13 while viewing the login screen displayed on the display 11 in front of the multi-function peripheral/printer 1.

Alternatively, the user who logs in may input the login information while viewing the login screen displayed on the terminal 5 connected to the multi-function peripheral/printer 1 via the communicator 19 and the network 3. In this case, in step S1, the controller 25 transmits the login screen to the terminal 5 via the communicator 19 and the network 3. In step S3, the controller 25 receives the login information from the terminal 5 via the communicator 19 and the network 3.

Next, the controller 25 determines the set default display screen on the basis of the setting information stored in advance in the storage 23 (step S5).

An administrator or the like of the multi-function peripheral/printer 1 sets the default display screen of the multi-function peripheral/printer 1 in advance before starting normal operation of the multi-function peripheral/printer 1. The administrator or the like sets the default display screen via a setting screen (not illustrated). This setting is stored in the storage 23. In step S5, the controller 25 selects the default display screen on the basis of the setting stored in the storage 23 and displays the default display screen on the display 11.

When a screen other than the home screen is set as the default display screen (step S5, other than home screen), the controller 25 displays the logout button in the details view on the screen set as the default display screen (step S7). The details view corresponds to a first display form. Next, the controller 25 waits until a certain amount of time elapses (step S9, No) and, after the certain amount of time of, for example, about 1 to 5 minutes elapses (step S9, Yes), switches the display form of the logout button from the details view to the simplified view (step S11). The simplified view corresponds to a second display mode. When the details view and the simplified view are compared, the details view has many display items (icon and user name), and the simplified view has few display items (only icon).

The simplified view is a display form having a smaller display area than the details view. As long as the display area of the simplified view is smaller than the display area of the details view, the screen of the display 11 can be used to display other information by that amount. For example, an icon representing logout and text representing a user name may be displayed in the details view, whereas only the icon may be displayed with omission of the display of the text in the simplified view. In this case, the display area of the simplified view is reduced by the display area of the text. As another example, an icon representing logout, text representing a user name, and the text “Logout” may be displayed in the details view, whereas only the icon representing logout may be displayed with omission of the user name and the text “Logout” in the simplified view. In this case as well, the display area of the simplified view is reduced by the display area of the text. As another example, any one of the details views described above may be displayed in the details view, and the text may be displayed in an abbreviated form in the simplified view. The abbreviated form refers to text having the same meaning as or corresponding to the original text, but with fewer characters than the original text. For example, the abbreviated form may display only the user's initials, or display only the first few characters (two characters, for example) of the user's name.

Herein, an icon is represented by an image, but an icon may also be represented by characters (including letters, numbers, Japanese characters, symbols, or the like) or a shape, for example. Further, the icon may be an identifier displayed as a simple character instead of an image.

When the home screen is set as the default display screen (step S5, home screen), the controller 25 displays the logout button in the details view on the home screen (step S15).

After step S11 or S15, the controller 25 determines whether the screen has been touched (step S13). The screen is a screen of a touch display in which the display 11 and the operation inputter 13 are integrally configured. At this time, the screen particularly operates as the operation inputter 13.

When the operation inputter 13 detects a touch on the touch screen (step S13, Yes), the controller 25 determines where the screen was touched (step S17).

When the region of the screen of the touch display where the logout button is displayed is touched (step S17, logout button), the controller 25 executes processing for logging out the currently logged-in user (step S19), and proceeds to step S1.

When a region of the screen of the touch display where a button other than the logout button is displayed is touched (step S17, other button), the controller 25 executes the function assigned to the touched button (step S21), and proceeds to step S5.

When a region of the screen of the touch display other than regions to which specific functions are assigned, such as buttons including the logout button, is touched (step S17, other than buttons), the controller 25 proceeds to step S5 as is.

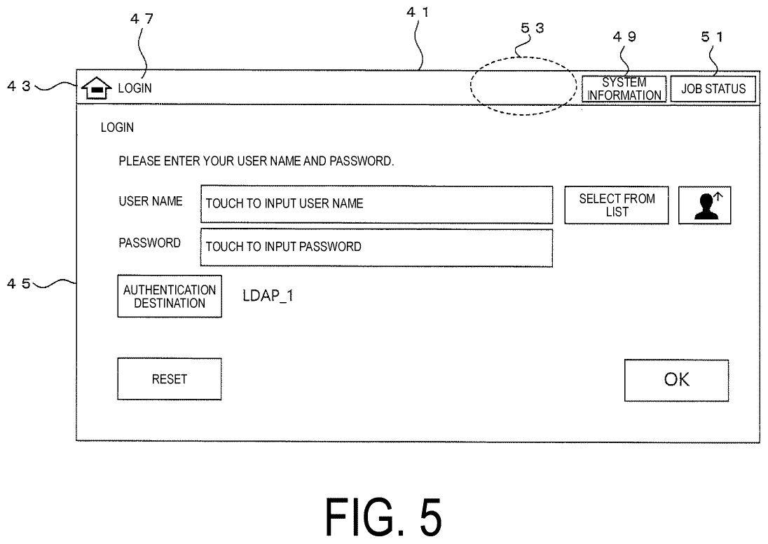

FIG. 5 is an example of a login screen displayed on the display 11 of the multi-function peripheral/printer 1. The login screen is displayed in steps S1 and S3. A login screen 41 is divided into upper and lower portions, and includes a system region 43 and a main region 45. The system region 43 is a rectangular region disposed in the upper portion of the screen. The main region 45 is a rectangular region disposed below the system region 43.

The system region 43 includes a mode name display 47, a system information button 49, a job status button 51, and a region 53. The mode name display 47 indicates the name of the operation mode associated with the login screen 41, and indicates login mode on the login screen 41. The system information button 49 is a button that, in response to touch, causes the controller 25 to display the system information of the multi-function peripheral/printer 1 on the display 11. The job status button 51 is a button that, in response to touch, causes the controller 25 to display the status of a job being executed in the multi-function peripheral/printer 1 on the display 11. Note that, on the login screen 41, nothing is displayed in the region 53.

The main region 45 is a region for inputting a user name, a password, and the like of the user attempting login in step S3. The user name may be directly input in the input field, or may be selected and input from a list of user names (not illustrated) displayed in response to a “Select from list” button being touched.

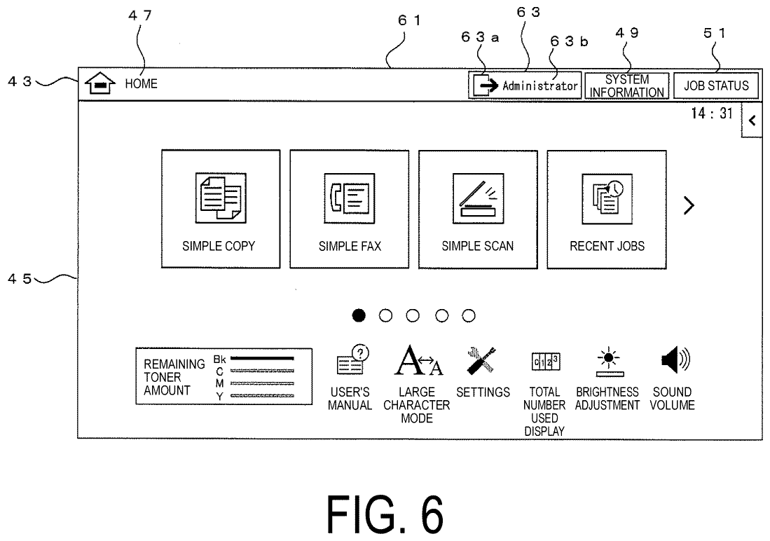

FIG. 6 is an example of a home screen displayed on the display 11 of the multi-function peripheral/printer 1. A home screen 61 is displayed on the display 11 in step S15. In the mode name display 47, “Home” indicating that the screen is the home screen (home operation mode) is displayed. As with the login screen 41, the home screen 61 includes the system region 43 and the main region 45. Further, as with the login screen 41, the system region 43 of the home screen 61 displays the system information button 49 and the job status button 51. However, on the home screen 61, a logout button 63 is displayed in the region 53 that is blank on the login screen 41.

The logout button 63 is a button that, in response to touch, causes the controller 25 to execute a logout process of the user who is currently logged into the multi-function peripheral/printer 1. The logout button 63 includes an icon 63a and a user name display 63b. The icon 63a is an icon illustrating the logout process. The user name display 63b displays the name of the user currently logged into the multi-function peripheral/printer 1. The home screen 61 is displayed after login of the user having the user name “Administrator” in step S3.

On the home screen 61, the logout button 63 is displayed in the details view. Therefore, in addition to the icon 63a, the user name display 63b is displayed on the logout button 63.

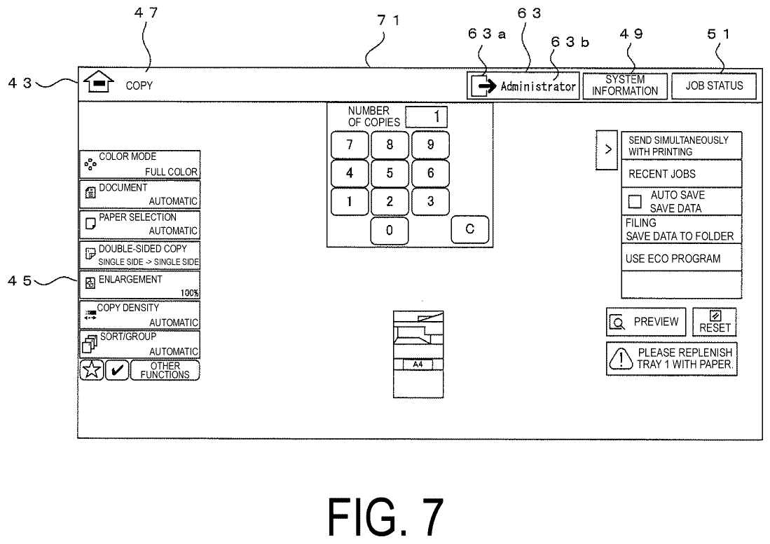

FIG. 7 is an example of a copy screen displayed on the display 11 of the multi-function peripheral/printer 1. A copy screen 71 is displayed on the display 11 in step S7. The copy screen 71 is a screen displayed on the display 11 when the multi-function peripheral/printer 1 is in copy operation mode. The copy screen 71 is an example of a copy screen and is also an example for explaining the display of the logout button 63 when a screen other than the home screen is selected as the default display screen in step S5.

When compared with the system region 43 of the home screen 61, the system region 43 of the copy screen 71 is the same except that the mode name display 47 is “Copy.” In step S7, the logout button 63 is displayed in the details view, and the user name display 63b is displayed together with the icon 63a.

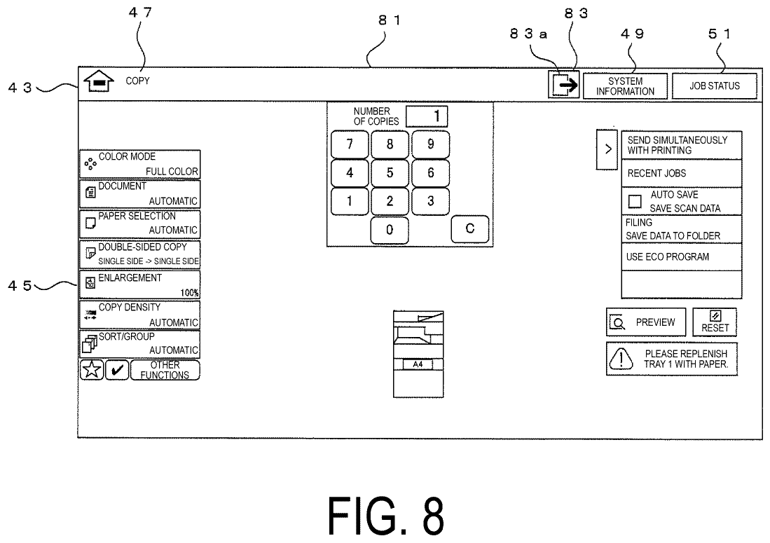

FIG. 8 is an example of a copy screen displayed on the display 11 of the multi-function peripheral/printer 1. A copy screen 81 is displayed on the display 11 in step S11. The copy screen 81 is a screen displayed on the display 11 when the multi-function peripheral/printer 1 is in copy operation mode and a certain amount of time has elapsed (step S9) after display of the copy screen 71. In the system region 43 of the copy screen 71, the logout button 63 is displayed in details view, that is, both the icon 63a and the user name display 63b are displayed. However, in the system region 43 of the copy screen 81, a logout button 83 is displayed in simplified view. When compared with the logout button 63 of the details view, the logout button 83 of the simplified view differs in including only the icon 83a and not including the user name display. Note that the images of the icon 63a and the icon 83a are the same. With the logout button 83 being displayed in the simplified view, the system region 43 of the copy screen 81 has a large margin as compared with that of the system region 43 of the copy screen 71. The term margin refers to a display state of the screen in which only the background is displayed. This makes it possible for the system region 43 of the copy screen 81 to additionally display other information.

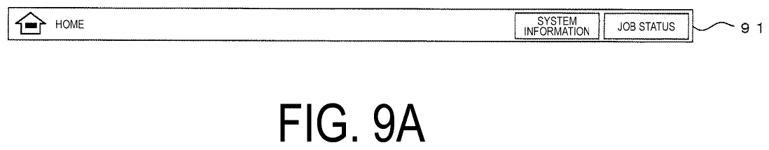

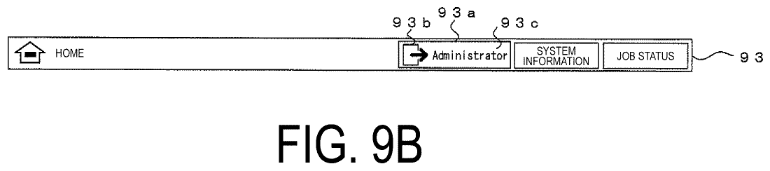

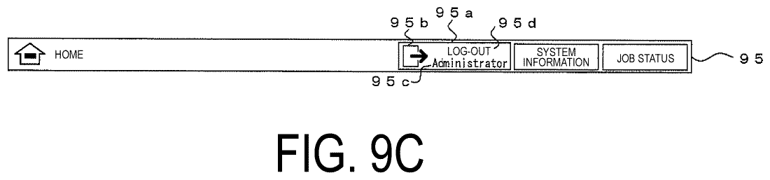

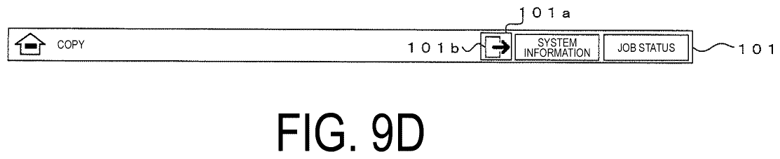

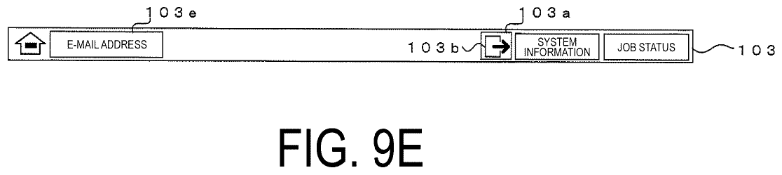

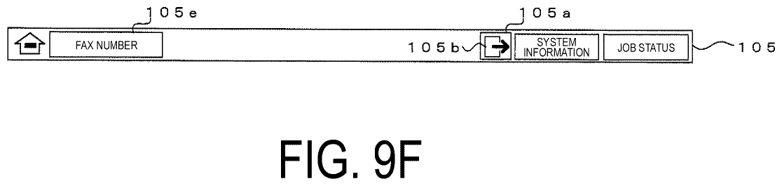

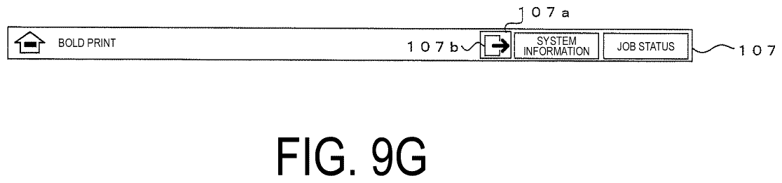

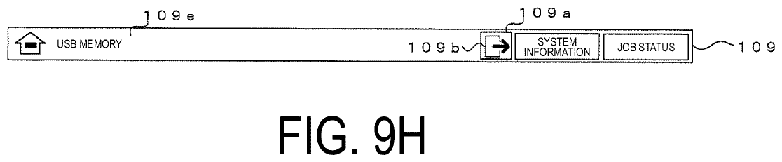

FIG. 9A to FIG. 9H illustrate examples of the system region. Hereinafter, the system regions of FIG. 9A to FIG. 9H will be described.

A system region 91 in FIG. 9A is a system region of the home screen without a user being logged in.

A system region 93 of FIG. 9B corresponds to the system region 43 of the home screen 61, and includes a logout button 93a of the details view. Therefore, the logout button 93a includes both an icon 93b and a user name display 93c.

A system region 95 of FIG. 9C includes a logout button 95a of the details view as in the system region 93 of FIG. 9B. However, the logout button 95a includes a process name display 95b in addition to an icon 95c and a user name display 95d. The process name display 95d indicates the name “Logout” of the process executed when the logout button 95a is touched.

Thus, the logout button of the details view is not limited to including the icon 93b and the user name display 93c as illustrated in FIG. 9B, and may include the icon 95b, the user name display 95c, and the process name display 95d as illustrated in FIG. 9C. Furthermore, other information may be additionally displayed on the logout button of the details view, as necessary.

A system region 101 of FIG. 9D corresponds to the system region 43 of the copy screen 81 of FIG. 8. The system region 101 includes an icon 101b in the logout button 101a.

A system region 103 in FIG. 9E is an example of the system region in scan operation mode. The system region 103 includes an e-mail address field 103e instead of displaying “Scan” or the like as the mode name display. When an image generated by scanning a document is attached to an e-mail and transmitted via the image inputter 15, the user can input a desired address in the e-mail address field 103e to designate a destination of the e-mail. Although only one e-mail address field 103e is displayed in FIG. 9E, a logout button 103a is displayed in the simplified view of only the icon 103b in the system region 103, and thus a plurality of e-mail address fields 103e can be arranged and simultaneously displayed in the system region 103. Further, instead of adding an e-mail address field 103e on a one-to-one basis with each address, a plurality of addresses may be displayed in one e-mail address field 103e. In this case, the display region of the e-mail address field 103e can be enlarged in accordance with the number of input addresses. Further, under the assumption that a plurality of addresses are input, the display region of the e-mail address field 103e can be enlarged to the maximum in advance. Enlargement of the display region of the e-mail address field 103e refers to, for example, in FIG. 9E, extending the e-mail address field 103e in a right direction in the drawing so that a right side of the e-mail address field 103e is near a left end of the logout button 103a.

A system region 105 in FIG. 9F is an example of the system region in fax operation mode. The system region 105 includes a fax number field 105e instead of displaying “Fax” or the like as the mode name display. When an image generated by scanning a document is transmitted as a fax via the image inputter 15, the user can input a desired fax number in the fax number field 105e to designate a destination of the fax. In the system region 105 as well, a logout button 105a is displayed in the simplified view of only an icon 105b and thus, as with the e-mail address field 103e in the system region 103, a plurality of the fax number fields 105e can be arranged and simultaneously displayed in the system region 105. Further, instead of adding a fax number field 105e on a one-to-one basis with a fax number, a plurality of fax numbers may be displayed in one fax number field 105e. In this case, the display region of the fax number field 105e can be enlarged in accordance with the number of input fax numbers. Further, under the assumption that a plurality of fax numbers are input, the display region of the fax number field 105e can be enlarged to the maximum in advance. Enlargement of the display region of the fax number field 105e refers to, for example, in FIG. 9F, extending the fax number field 105e in a right direction in the drawing so that a right side of the fax number field 105e is near a left end of the logout button 105a.

A system region 107 illustrated in FIG. 9G is an example of the system region displayed when the multi-function peripheral/printer 1 is in hold print operation mode. Hold print operation mode is an operation mode in which one or more documents held in the multi-function peripheral/printer 1 can be printed. Hold print operation mode allows confirmation of one or more data to be output, a number of sheets required for printing, and the like on the multi-function peripheral/printer 1 before actual output of printed material.

A system region 109 in FIG. 9H is an example of the system region displayed when the multi-function peripheral/printer 1 is in direct print operation mode. Direct print operation mode is an operation mode in which the multi-function peripheral/printer 1 executes printing on the basis of data read from an external storage device directly connected via an interface of the connector 21, not via the network 3 and the communicator 19. In the system region 109, instead of the mode name display, “USB memory” is displayed as a read source display 109e indicating a read source of data.

According to the multi-function peripheral/printer 1 of the present embodiment, there is a relatively large margin in the display in the system region 43 on the home screen 61, and thus the logout button 63 is displayed in the details view in which both the icon 63a and the user name display 63b are displayed. At this time, the user name of the logged-in user can be easily visually recognized.

On the other hand, on the copy screen 71 or the like other than the home screen, the logout button 63 is displayed in the details view as on the home screen 61 at the start of display and then, after a while, the logout button 83 is displayed in the simplified view including the icon 83a but not including the user name display. The simplified view requires only a small space for displaying the logout button, making it possible to sufficiently secure space for displaying additional information such as, for example, the e-mail address field 103e in FIG. 9E and the fax number field 105e in FIG. 9F in the system region.

Note that, in the present embodiment, the icon and the user name are displayed with the logout button of the details view, and only the icon is displayed with the logout button of the simplified view. However, the display contents of the details view and the simplified view are not limited thereto. For example, as illustrated in FIG. 9C, the process name may be displayed in addition to the icon and the user name on the logout button of the details view.

Further, although the icon displayed in the details view and the icon displayed in the simplified view have the same image in the present embodiment, the disclosure is not limited thereto. For example, an image obtained by reducing a size of the icon displayed in the details view may be displayed as the icon in the simplified view. Alternatively, another icon having a simpler design than the icon displayed in the details view may be displayed as the icon in the simplified view.

Although the details view includes many display items (icon and user name) and the simplified view includes few display items (only icon) in the above description, the display area of the simplified view may be reduced by reducing the details view in a horizontal direction of the screen without changing the number of display items. For example, a length of the user name display may be shortened by displaying only the first few characters of the character string constituting the user name and omitting subsequent characters.

Further, although the logout button is arranged in the system region in the embodiment described above, an account management button may be arranged instead of arranging the logout button. When the account management button is touched, the controller 25 displays an account management screen (not illustrated) that displays account information of the logged-in user. The logout button is arranged on the account management screen. In the embodiment described above, the user name display of the logout button displays a character string indicating the user name. However, an avatar, a figure, an initial display, or the like indicating the user may be displayed on the account management screen. Then, preferably an arrow indicating logout (exit) is displayed together with the user name, the avatar, the figure, the initial display, or the like, emphasizing that the menu is not a simple account management menu.

Although the display form of the logout button is basically selected in accordance with the operation mode in the embodiment described above, the display form of the logout button may be selected in accordance with the size of the margin of the system region, regardless of the operation mode. For example, when a margin area of the system region is smaller than a threshold area, the controller 25 displays the logout button in the simplified view in the system region and, when the margin area is equal to or larger than the threshold area, the controller 25 displays the logout button in the details view in the system region. Further, the display form of the logout button may be selected in accordance with a combination of the operation mode and a comparison result between the margin area of the system region and the threshold area. For example, in the first operation mode (home screen), the details view may be set regardless of the margin area of the system region. On the other hand, in the second operation mode (other than home screen), the details view may be set when the margin area of the system region is equal to or larger than the threshold area, and the simplified view may be set when the margin area is smaller than the threshold area.

Further, in the embodiment described above, only the icon is displayed in the logout button of the simplified view, but a so-called hamburger menu may be displayed instead. The hamburger menu is, for example, a menu button having a shape in which three horizontal lines of equal length aligned in parallel are surrounded by a rectangle, such as [≡].

### 2. Second Embodiment

A second embodiment will now be described. The second embodiment is an embodiment in which the display mode is changed on the home screen. Note that only portions differing in configuration and processing from the first embodiment will be mainly described.

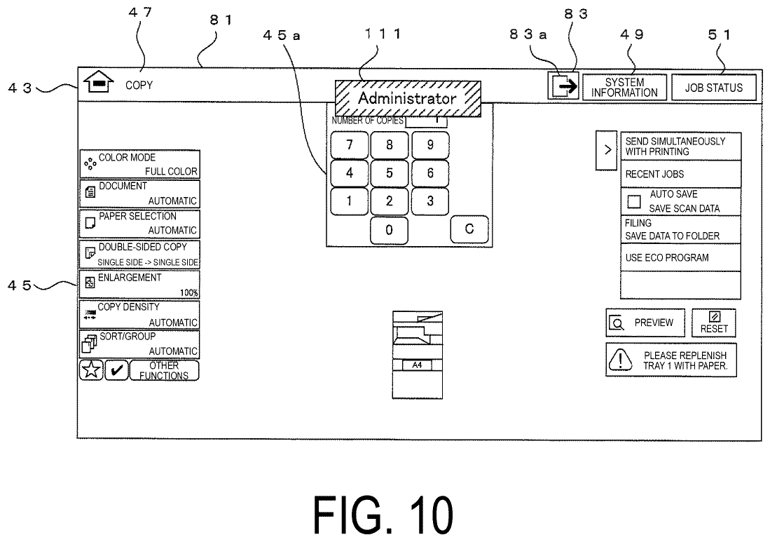

FIG. 10 is an example of the copy screen displayed on the display 11 of the multi-function peripheral/printer 1. In the first embodiment described above, when the default display screen is determined to be other than the home screen in step S5, the copy screen 71 of FIG. 7 is displayed. However, in the second embodiment, the copy screen 81 of FIG. 8 is displayed and, for a predetermined period (for example, five to 10 seconds) immediately after the start of display, a toast display 111 is displayed superimposed on a boundary between the system region 43 and the main region 45. As illustrated in FIG. 10, the toast display 111 is displayed superimposed on other various screen elements (for example, numeric keypad 45a) disposed in the system region 43 and the main region 45.

The toast display 111 displays the user name of the logged-in user. The toast display 111 may display other information instead of or in addition to the user name. For example, the toast display 111 may display information associated with the user, such as an image associated with the user name (for example, image of a headshot of the user or an icon indicating the user) or a character string indicating a department associated with the user.

A display position of the toast display 111 is not limited on the boundary line between the system region 43 and the main region 45. For example, the toast display 111 may be displayed superimposed at a central portion of the main region 45.

Furthermore, a size of the toast display 111 is not limited to that illustrated, and may be, for example, a size that covers the system region 43 and main region 45 as a whole.

According to the second embodiment, even in a case in which the logout button is displayed in the simplified view immediately after the user logs into the multi-function peripheral/printer 1, the toast display 111 is displayed superimposed on other screen elements, making it possible to notify the person operating the multi-function peripheral/printer 1 of the login user name.

### 3. Third Embodiment

A third embodiment will now be described. The third embodiment is an embodiment in which the display form of the logout button is changed from the simplified view to the details view. Note that only portions differing in configuration and processing from the first embodiment will be mainly described.

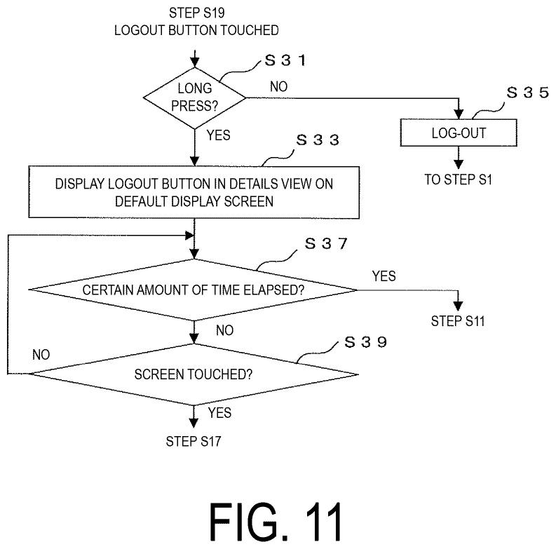

FIG. 11 is a flowchart for explaining the operation of the multi-function peripheral/printer 1 according to the third embodiment. This flowchart replaces part of the flowchart of FIG. 4. Note that, in the third embodiment, it is assumed that the user inputs login information from the operation inputter 13 of the multi-function peripheral/printer 1 to log into the multi-function peripheral/printer 1.

When the logout button is touched in step S19 of the flowchart of FIG. 4, this process proceeds to step S31 of FIG. 11 instead of proceeding to step S1. In step S31, the controller 25 determines whether the touch on the logout button is a long press.

That is, upon detection of the start of the touch on the logout button, the controller 25 stores the time as a touch start time in the storage 23. Then, upon detection of completion of the touch on the logout button, the controller 25 stores the time as a touch end time in the storage 23. The controller 25 finds a difference between the touch end time and the touch start time as a touch time, and compares the touch time with a threshold time stored in advance in the storage 23. The threshold time is, for example, 3 to 5 seconds. When the touch time is shorter than the threshold time, the controller 25 determines that a normal touch has been performed. When the touch time is equal to or longer than the threshold time, the controller 25 determines that a long press has been performed.

When the determination is made that the touch is a normal touch (step S31, No), the controller 25 executes a logout process and proceeds to step S1. When the determination is made that the long press has been performed (step S31, Yes), the controller 25 displays the logout button in the details view on the screen set as the default display screen (step S33).

When a certain amount of time (for example, about 1 to 5 minutes) has elapsed without the screen being touched after the logout button is touched (step S37, Yes), the controller 25 proceeds to step S11 in FIG. 4. If the screen is touched before the certain amount of time elapses (step S39, Yes), the controller 25 proceeds to step S17. The steps after step S17 are the same as those in FIG. 4, and thus description thereof will be omitted.

According to the third embodiment, it is possible to confirm the name of the logged-in user before execution of logout by changing the logout button in the simplified view to the details view by a long press, making it possible to prevent unintended logout.

### 4. Fourth Embodiment

A fourth embodiment will now be described. The fourth embodiment is an embodiment that deals with a case in which the user steps away from the multi-function peripheral/printer 1 without performing a logout operation. Only portions differing in configuration and processing from the first embodiment will be mainly described.

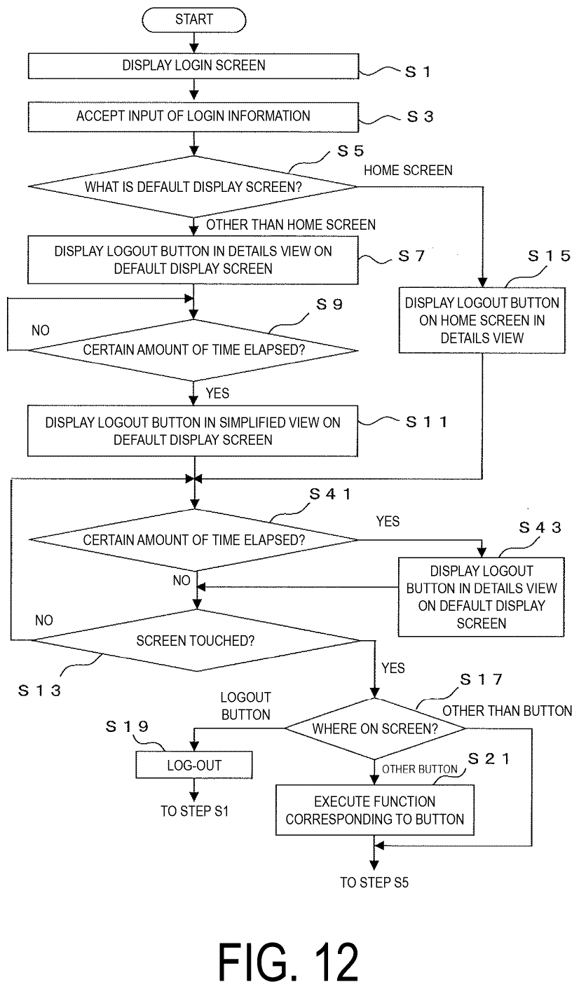

FIG. 12 is a flowchart for explaining operation when the multi-function peripheral/printer 1 does not receive an operation for a certain amount of time. The flowchart of FIG. 12 differs from the flowchart of FIG. 4 mainly in including steps S41 and S43. Note that, in the fourth embodiment, it is assumed that a user logging into the multi-function peripheral/printer 1 inputs login information from the operation inputter 13 and logs into the multi-function peripheral/printer 1.

The operation up to step S9 is the same as that of the first embodiment, and thus description thereof will be omitted. In step S11, the controller 25 displays the logout button in the simplified view, sets a time after elapse of a predetermined standby time (for example, 3 minutes) from the current time as an end time, and compares the current time with the end time.

When the current time reaches the end time before the screen is touched (step S41, Yes), the controller 25 changes the display form of the logout button to the details view (step S43). In a situation in which the screen is not touched even after the standby time elapses after the display form of the logout button is changed to the simplified view, there is a possibility that the currently logged-in user is away from the multi-function peripheral/printer 1 and the user who will view the logout button next will not be the currently logged-in user. Further, there may be a case in which another user will log into the multi-function peripheral/printer 1 while the currently logged-in user is away from the multi-function peripheral/printer 1. Therefore, in the fourth embodiment, the display form of the logout button is changed to the details view including the user name display in step S43 in order to notify the next user viewing the logout button of the currently logged-in user.

### 5. Fifth Embodiment

A fifth embodiment will now be described. The fifth embodiment is an embodiment that deals with a case in which the user steps away from the multi-function peripheral/printer 1 without performing a logout operation. Only portions differing in configuration and processing from the first embodiment will be mainly described.

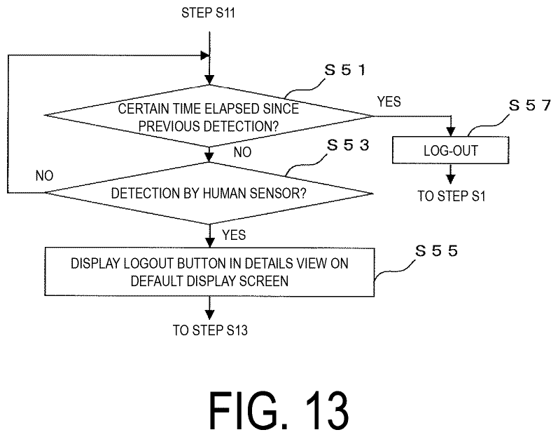

FIG. 13 is a flowchart for explaining the operation of the multi-function peripheral/printer 1 according to the fifth embodiment. In the fifth embodiment, the controller 25 determines whether there is a person in the vicinity of the multi-function peripheral/printer 1 using the human sensor 27 and, if so, stores the time in the storage 23.

After steps S11, S15, and No in step S13, the controller 25 finds a difference between the time stored in the storage 23 as the last time when a person was detected by the human sensor 27 and the current time, and compares the difference with a predetermined threshold to determine whether a certain standby time has elapsed from the time when a person was last detected near the multi-function peripheral/printer 1 (step S51). Here, the standby time is, for example, about 1 to 5 minutes.

In a case in which the standby time has elapsed without the human sensor 27 next detecting a person (step S51, yes), the controller 25 executes the logout process for the user currently logged into the multi-function peripheral/printer 1 (step S57), and proceeds to step S1. This allows a new user to execute his/her own login process without performing the logout process of the other user.

In a case in which the human sensor 27 detects a person before the standby time elapses (step S53, Yes), the controller 25 changes the display form of the logout button to the details view (step S55) and proceeds to step S13. Before the standby time elapses, the login state is maintained due to the possibility that the logged-in user who stepped away from the multi-function peripheral/printer 1 will return to the multi-function peripheral/printer 1 again.

### 6. Modified Examples

The disclosure is not limited to the embodiments described above and can be changed in various manners. That is, embodiments obtained by combining technical mechanisms appropriately changed without departing from the gist of the disclosure are also included in the technical scope of the disclosure.

The programs running on each device in the embodiments are programs for controlling a CPU or the like (programs for causing a computer to function) to implement the aforementioned functions in the embodiments. The information handled by these devices is temporarily accumulated in a transitory storage device (for example, a RAM) at the time of processing, is then stored in a storage device such as various read only memories (ROMs) or HDDs, and is read, corrected, and written by the CPU as needed.

The recording medium storing the programs may be any of a semiconductor medium (for example, a ROM or a nonvolatile memory card), an optical recording medium or a magneto-optical recording medium (for example, a digital versatile disc (DVD), a magneto optical disc (MO), a mini disc (MD), a compact disc (CD), or a Blu-ray (trade name) disc (BD)), a magnetic recording medium (for example, a magnetic tape or a flexible disk), and the like. Not only the aforementioned functions of the embodiments are implemented by executing the loaded programs, but also the functions of the disclosure may be implemented by performing processing in cooperation with an operating system, another application program, or the like based on commands of the programs.

In a case where the programs are distributed to market, the programs can be stored and distributed in a portable recording medium, or can be transferred to a server computer connected via a network such as the Internet. In this case, it is a matter of course that the storage device of the server computer is also included in the disclosure.

### REFERENCE SIGNS LIST

1 Multi-function peripheral/printer (MFP)
3 Network
5 Terminal
11 Display
13 Operation inputter
15 Image inputter
17 Image former
19 Communicator
21 Connector
23 Storage
25 Controller
27 Human sensor
41 Login screen
43, 91, 93, 95, 101, 103, 105, 107, 109, 121 System region
45 Main region
45a Numeric keypad
47 Mode name display
49, 123 System information button
51, 125 Job status button
53 Region
61 Home screen
63, 83, 93a, 95a, 101a, 103a, 105a, 107a, 109a, 127 Logout button
63a, 83a, 93b, 95b, 101b, 103b, 105b, 107b, 109b, 127a Icon
63b, 93c, 95c, 127b User name display
71, 81 Copy screen
95d, 127c Process name display
103e E-mail address field
105e Fax number field
111 Toast display

1. An image forming apparatus comprising:
one or more controllers; and
a display,
wherein the one or more controllers
display, when a screen corresponding to a first operation mode is displayed on the display, a logout related display on the screen corresponding to the first operation mode in a first display form, and
display, when a screen corresponding to a second operation mode is displayed on the display, the logout related display on the screen corresponding to the second operation mode in a second display form different from the first display form.

2. The image forming apparatus according to claim 1,
wherein the second display form has a display area smaller than that of the first display form.

3. The image forming apparatus according to claim 1,
wherein the logout related display is displayed using text and an icon in the first display form, and
the logout related display is displayed using an icon in the second display form.

4. The image forming apparatus according to claim 1,
wherein, when the screen corresponding to the second operation mode is displayed on the display, the logout related display is displayed on the screen corresponding to the second operation mode in the second display form in accordance with a margin area of the screen corresponding to the second operation mode.

5. The image forming apparatus according to claim 4,
wherein, when the screen corresponding to the second operation mode is displayed on the display, the logout related display is displayed on the screen corresponding to the second operation mode in the second display form in accordance with a comparison result between the margin area of the screen corresponding to the second operation mode and a predetermined threshold area.

6. The image forming apparatus according to claim 1,
wherein, in the first operation mode, the one or more controllers display a plurality of operation modes on the display in a selectable manner, and
in the second operation mode, the one or more controllers display a screen corresponding to an operation mode selected from the plurality of operation modes in the first operation mode.

7. An operation method of an image forming apparatus including one or more controllers and a display, the operation method comprising:
causing the one or more controllers to
display, when a screen corresponding to a first operation mode is displayed on the display, a logout related display on the screen corresponding to the first operation mode in a first display form, and
display, when a screen corresponding to a second operation mode is displayed on the display, the logout related display on the screen corresponding to the second operation mode in a second display form different from the first display form.
